(19) United States
(12) Patent Application Publication
(10) Pub. No.: US 2026/0003757 A1
(43) Pub. Date: Jan. 1, 2026

(54) SYSTEMS AND METHODS FOR DETECTION OF ABNORMAL CONDITIONS DURING OPERATION OF COMPUTING DEVICE

(71) Applicant: Quanta Computer Inc., Taoyuan City (TW)

(72) Inventors: Ching-Keng FANG, Taoyuan City (TW); Yung-Fu LI, Taoyuan City (TW)

(21) Appl. No.: 18/761,083

(22) Filed: Jul. 1, 2024

(51) Int. Cl. G06F 11/30; G06F 1/20

(52) U.S. Cl. CPC G06F 11/3058; G06F 1/206

(57) ABSTRACT

A method of monitoring a computing device includes receiving audio data associated with sound made by the computing device during operation. The method further includes receiving fan speed data associated with a fan speed of each of one or more fans of the computing device. The method further includes determining, based at least on the audio data and the fan speed data, a normality state of the computing device. The normality state is associated with a presence or absence of one or more abnormal conditions that affect the sound made by the computing device during operation.

### FIELD OF THE INVENTION

The present invention relates generally to systems and methods for the detection of abnormal conditions present during the operation of a computing device, and more specifically, to systems and methods for analyzing audio data using machine learning techniques to detect the presence of any abnormal conditions present during the operation of the computing device.

### BACKGROUND OF THE INVENTION

Many computing devices, such as servers, are designed to operate continuously or near-continuously over long periods of time. As the computing device operates, a variety of abnormal conditions may appear, such as loose screws, loose connections to various mechanical components (such as expansion cards, cables, etc.), or blockages of pathways for air flow that is used to cool the computing device. Because these abnormal conditions are generally physical in nature and not detectable through remote management of the computing device (e.g., via a remote connection to a baseboard management controller), such abnormal conditions are often only detectable via physical inspection of the computing device. However, many of these computing devices are remotely located or otherwise not accessed frequently, and thus detection of these abnormal conditions may be difficult. Thus, new systems and methods are needed for detecting abnormal conditions during operation of a computing device.

### SUMMARY OF THE INVENTION

The term embodiment and like terms, e.g., implementation, configuration, aspect, example, and option, are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings, and each claim.

In a first implementation, the present disclosure is directed to a method of monitoring a computing device that includes receiving audio data associated with sound made by the computing device during operation. The method further includes receiving fan speed data associated with a fan speed of each of one or more fans of the computing device. The method further includes determining, based at least on the audio data and the fan speed data, a normality state of the computing device. The normality state is associated with a presence or absence of one or more abnormal conditions that affect the sound made by the computing device during operation.

In some aspects of the first implementation, the normality state is associated with a plurality of variables. A value of each of the plurality of variables indicates whether a respective one of the one or more abnormal conditions is present.

In some aspects of the first implementation, the plurality of variables includes at least one variable associated with an air inlet of the computing device, at least one variable associated with an air outlet of the computing device, at least one variable associated with one or more mechanical components coupled to the computing device, at least one variable associated with one or more fasteners coupled to or disposed within the housing of the computing device, or any combination thereof.

In some aspects of the first implementation, the value of the at least one variable associated with the air inlet indicates a degree of blockage of the air inlet.

In some aspects of the first implementation, the value of the at least one variable associated with the air outlet indicates a degree of blockage of the air outlet.

In some aspects of the first implementation, the value of the at least one variable associated with the one or more mechanical components indicates a degree of looseness of the coupling between the one or more mechanical components and the computing device.

In some aspects of the first implementation, the value of the at least one variable associated with the one or more fasteners indicates a degree of looseness of the one or more fasteners.

In some aspects of the first implementation, the method further includes generating a message indicating the normality state of the computing device. The message includes (i) the value of each of the plurality of variables, (ii) an indication of whether at least one of the one or more abnormal conditions is present, or (iii) both (i) and (ii).

In some aspects of the first implementation, the indication of whether at least one of the one or more abnormal conditions is present includes (i) an indication that none of the one or more abnormal conditions is present or (ii) an indication that at least one of the one or more abnormal conditions is present.

In some aspects of the first implementation, when at least one of the one or more abnormal conditions is present, the indication includes information associated with: (i) an identification of the at least one of the one or more abnormal conditions; (ii) a category of the at least one of the one or more abnormal condition; (iii) a location of the at least one of the one or more abnormal condition; (iv) a degree of the at least one of the one or more abnormal condition; or (iv) any combination of (i)-(iv).

In some aspects of the first implementation, the one or more abnormal conditions includes: (i) at least a partial blockage of the air inlet; (ii) at least a partial blockage of the air outlet; (iii) a loosening of the coupling of at least one of the one or more mechanical components; (iv) a loosening of at least one of the one or more fasteners; or (v) any combination of (i)-(iv).

In some aspects of the first implementation, determining the normality state of the computing device includes inputting the audio data and the fan speed data into a machine learning model, and receiving from the machine learning model an indication of the normality state of the computing device.

In some aspects of the first implementation, the machine learning model is a neural network.

In some aspects of the first implementation, the machine learning model is a recurrent neural network (RNN) with at least one long short-term memory (LSTM) unit.

In some aspects of the first implementation, the machine learning model is implemented by a baseboard management controller (BMC) of the computing device.

In some aspects of the first implementation, the audio data includes pulse-code modulation (PCM) audio data with a sampling rate of 16 kilohertz and a bit depth of 16.

In some aspects of the first implementation, the one or fans of the computing device include at least one fan configured to remove heat from a power supply unit (PSU) of the computing device; at least one fan configured to remove heat from a central processing unit (CPU) of the computing device; or both.

In some aspects of the first implementation, the normality state of the computing device is indicative of a difference between: (i) the sound made by the computing device during operation; and (ii) sound made by the computing device during operation without any abnormal conditions, the difference being caused by the presence of at least one of the one or more abnormal conditions.

In a second implementation, the present disclosure is directed to a computing device that includes a housing, one or more electronic components, one or more fans, a microphone, and a baseboard management controller (BMC). The housing has an air inlet and an air outlet defined therein. The one or more electronic components are disposed at least partially within the housing. The one or more fans are configured to cause air to flow through the housing and remove heat generated by the one or more electronic components. The microphone is disposed at least partially within the housing and is configured to generate audio data associated with sound made by the computing device during operation. The BMC is disposed within the housing and is communicatively coupled to at least the one or more fans and the microphone. The BMC is configured to receive, from the microphone, the generated audio data associated with the sound made by the computing device during operation. The BMC is further configured to receive, from the one or more fans, fan speed data associated with a fan speed of each of the one or more fans. The BMC is further configured to determine, based at least on the audio data and the fan speed data, a normality state of the computing device, the normality state being associated with whether the computing device is operating under a presence of one or more abnormal conditions.

In a third implementation, the present disclosure is directed to a method of training a machine learning model to determine the normality state of a computing device having one or more fans. The method includes operating the computing device using a plurality of different fan speeds of the one or more fans. The method further includes, for each of the plurality of different fan speeds, simulating or causing a plurality of abnormal conditions. The method further includes generating a plurality of sets of audio data. Each respective set of audio data is associated with sound made by the computing device during operation of the computing device with a combination of: (i) one of the plurality of different fan speeds; and (ii) either: (a) none of the plurality of abnormal conditions; or (b) one or more of the plurality of abnormal conditions. The method further includes generating a corresponding label for each respective one of the plurality of sets of audio data. The label indicates that the respective set of audio data corresponds to operation of the computing device (i) without any of the plurality of abnormal conditions present or (ii) with an identified one or more of the plurality of abnormal conditions. The method further includes training the machine learning model using each of the plurality of sets of audio data and the corresponding label for each respective one of the plurality of sets of audio data.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

The disclosure, and its advantages and drawings, will be better understood from the following description of representative embodiments together with reference to the accompanying drawings. These drawings depict only representative embodiments, and are therefore not to be considered as limitations on the scope of the various embodiments or claims.

FIG. 1 illustrates an example computing device, according to certain aspects of the present disclosure.

FIG. 2 is a flowchart of an example method for monitoring the computing device in FIG. 1 using audio data generated by a microphone, and fan speed data generated by fans.

FIG. 3 illustrates a method of training a machine learning model to determine the normality state of the computing device in FIG. 1.

### DETAILED DESCRIPTION

Various embodiments are described with reference to the attached figures, where like reference numerals are used throughout the figures to designate similar or equivalent elements. The figures are not necessarily drawn to scale and are provided merely to illustrate aspects and features of the present disclosure. Numerous specific details, relationships, and methods are set forth to provide a full understanding of certain aspects and features of the present disclosure, although one having ordinary skill in the relevant art will recognize that these aspects and features can be practiced without one or more of the specific details, with other relationships, or with other methods. In some instances, well-known structures or operations are not shown in detail for illustrative purposes. The various embodiments disclosed herein are not necessarily limited by the illustrated ordering of acts or events, as some acts may occur in different orders and/or concurrently with other acts or events. Furthermore, not all illustrated acts or events are necessarily required to implement certain aspects and features of the present disclosure.

For purposes of the present detailed description, unless specifically disclaimed, and where appropriate, the singular includes the plural and vice versa. The word “including” means “including without limitation.” Moreover, words of approximation, such as “about,” “almost,” “substantially,” “approximately,” and the like, can be used herein to mean “at,” “near,” “nearly at,” “within 3-5% of,” “within acceptable manufacturing tolerances of,” or any logical combination thereof. Similarly, terms “vertical” or “horizontal” are intended to additionally include “within 3-5% of” a vertical or horizontal orientation, respectively. Additionally, words of direction, such as “top,” “bottom,” “left,” “right,” “above,” and “below” are intended to relate to the equivalent direction as depicted in a reference illustration; as understood contextually from the object(s) or element(s) being referenced, such as from a commonly used position for the object(s) or element(s); or as otherwise described herein.

Disclosed herein are systems and methods for detecting abnormal conditions during the operation of a computing device, such as a server. The computing device will make a variety of different sounds during operation, such as via fans causing air to flow through a housing of the computing device, vibration due to moving parts such as hard disk drives, etc. A variety of abnormal conditions may also exist that affect the sound that is made by the computing device during operation. For example, if an air inlet of the housing is partially blocked, the sound made by computing device may be different than if the air inlet was unblocked. In another example, loose fasteners (e.g., screws) or mechanical components (e.g., expansion cards) may cause changes in the sound made by the computing device. Audio data associated with sounds made by the computing device during operation and fan speed data associated with the fan speed of any fans of the computing device can be collected and analyzed to determine a normality state of the computing device. The normality state is indicative of whether any abnormal conditions are present.

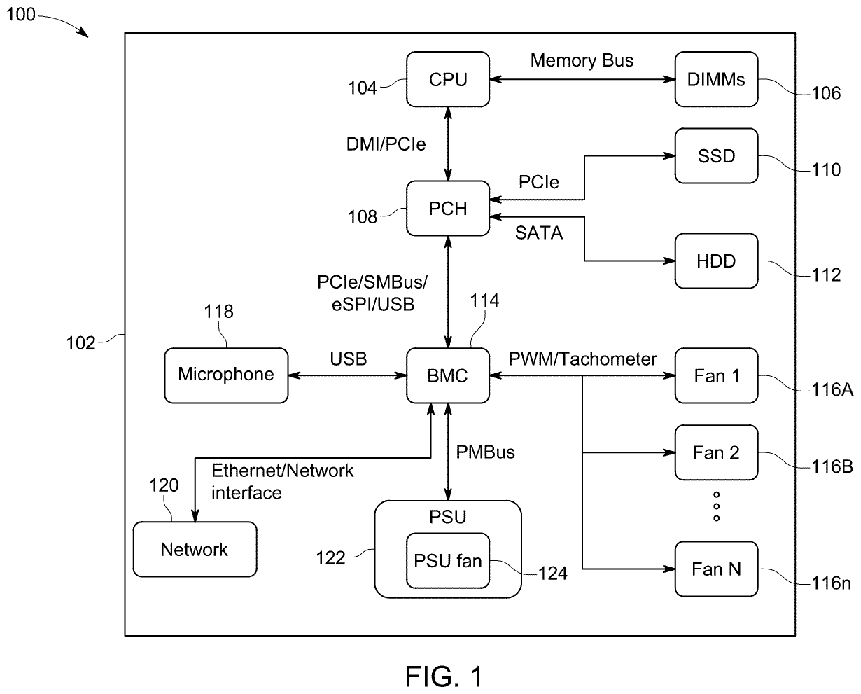

FIG. 1 illustrates a computing device 100 according to the present disclosure. In the illustrated implementation, the computing device 100 includes a housing 102, a central processing unit (CPU) 104, one or more memory devices 106 (shown as dual in-line memory modules, or DIMMs, in the illustrated implementation) coupled to the CPU 104 via a memory bus, a platform controller hub (PCH) 108, one or more solid-state drives (SSDs) 110 coupled to the PCH 108 via a peripheral component interconnect express (PCIe) bus, one or more hard disk drives (HDDs) 112 coupled to the PCH 108 via a serial AT attachment (SATA) bus, a baseboard management controller (BMC) 114, a plurality of fans 116A-116n coupled to the BMC 114 via a metered connection such as a pulse width modulation (PMW) connection or a tachymeter, and a microphone 118 coupled to the BMC 114 via a universal serial bus (USB). The BMC 114 may also be connected to an external network 120 via an Ethernet connection or some other network interface.

The CPU 104 controls the general operation of the computing device 100, and may execute a variety of different applications as needed. The PCH 108 is coupled to the CPU 104 via a direct media interface (DMI) bus or PCIe bus, facilitates communication between the CPU 104 and the SSDs 110 and the HDDs 112 (as well as any other components that may be coupled to the PCH 108). In some implementations, the computing device 100 may include different chips instead of and/or in addition to the PCH 108, such as a northbridge chip and/or a southbridge chip. These chips can generally perform many of the same functions as the PCH 108. In other configurations of computing devices similar to the computing device 100, the PCH 108 may be eliminated and other components of chipsets (e.g., AMD based chipsets, or ARM based chipsets) including a CPU may perform similar functions.

The BMC 114 manages operations of the computing device 100, such as power management and thermal management. For example, the BMC 114 can in some cases control the operation of the fans 116A-116n to cause air to flow through the housing 102 and remove heat from the computing device 100. For example, the fans 116A-116n may be operable to aid in removing heat that is generated by the CPU 104 and/or any other component or combination of components of the computing device 100. The BMC 114 also receives fan speed data associated with the speed of the fans 116A-116n via the metered connection between the BMC 114 and the fans 116A-116n. Further, as discussed in more detail herein, the BMC 114 can receive audio data generated by the microphone 118 that is associated with sound made by the computing device 100 during operation. In the illustrated implementation, the computing device 100 includes a single microphone 118, which may be disposed wholly inside the housing 102, partially inside and partially outside the housing 102, or wholly outside the housing 102. Moreover, while a single microphone 118 is illustrated in FIG. 1, some implementations may include multiple microphones. For example, the computing device 100 could include a first microphone disposed wholly (or partially) within the housing 102, and a second microphone disposed wholly (or partially) outside of the housing 102. In these implementations, the BMC 114 receives audio data from both microphones.

The BMC 114 communicates with the PCH 108 through a variety of different channels, such as a PCIe bus, a system management bus (SMB or SMBus), an enhanced serial peripheral interface (eSPI) bus, a USB, or any combination thereof. The network connection between the BMC 114 and the external network 120 allows for communication with external devices and systems. The BMC 114 typically manages the interface between the various components of the computing device 100 and system-management software, which may be used to control the operation of a larger computing system of which the computing device 100 is a part.

The computing device 100 further includes a power supply unit (PSU) 122. The PSU 122 provides power for all of the components of the computing device 100, including some or all of those shown in FIG. 1. In this example, the PSU 122 is configured to be connected to mains power and convert that AC voltage to DC voltage that is usable by the components of the computing device 100. Other PSUs may convert DC voltage inputs to DC voltage for powering a computing device. The PSU 122 includes a PSU fan 124 that is operable to cause air to flow past the PSU 122 (and/or any heat-removal related components of the PSU 122, such as a heat sink) to aid in removing heat from the PSU 122. The PSU 122 is coupled to the BMC 114 via a power management bus (PMBus), which allows the BMC 114 to control and monitor the PSU 122 and the PSU fan 124. Similar to the fans 116A-116n, the BMC 114 can also receive fan speed data associated with the speed of the PSU fan 124 via the PMBus connection between the BMC 114 and the PSU 122.

Generally, all of the components of the computing device 100 (which may include all or some of the components illustrated in FIG. 1) are disposed at least partially within the housing 102. Moreover, not all implementations will include every component of the computing device 100 that is illustrated in FIG. 1. In general, implementations according to the present disclosure will include at least the CPU 104, the BMC 114, the fans 116A-116n, the microphone 118, and the PSU 122 with PSU fan 124.

The computing device 100 will generate a variety of different sounds during operation. For example, the rotation of the fans 116A-116n and the PSU fan 124 when they are active can generate sound. The flow of the air caused by the fans 116A-116n and 124 may itself be audible as well. In another example, movement or vibration of mechanical components (such as the spinning of one of the HDDs 112) may generate sound, either by itself (e.g., the sound of the vibration) or by causing other mechanical components to vibrate or move (e.g., spinning of one of the HDDs 112 may cause a loose screw to vibrate and generate sound).

A variety of different factors may affect the sound that is made by the computing device 100 during operation. One factor that may affect the sound made by the computing device 100 whether there are any blockages of an air inlet and an air outlet of the housing 102. The air inlet and air outlet allow air to flow through the computing device 100 to aid in removing heat. If the air inlet and/or the air outlet are partially or wholly blocked (such as by dust, cables plugged into the housing 102, etc.), the sound caused by the air flowing through the housing 102 may sound different than if the air inlet and/or the air outlet are unblocked. A second factor may be looseness of any fasteners of the computing device 100. The computing device 100 may utilize a variety of different fasteners to attach different components, such as screws to couple different portions of the housing 102 or to couple a motherboard (on which components such as the CPU 104 and the PCH 108 may be mounted) to the housing 102, clips to removably attached components within the housing 102, etc. If any of these fasteners are loose (e.g., a screw that is not fully rightened), movement of the loose fastener (such as vibration) during operation of the computing device 100 may affect the sound made by the computing device 100. A third factor may be the looseness of any mechanical components (e.g. non-fasteners) disposed within and/or coupled to the housing 102. For example, the computing device 100 may include an expansion card plugged into a connector (such as a motherboard connector) within the housing 102. If the expansion card is not fully seated in the connector or is otherwise loose, movement of the expansion card (such as vibration) may affect the sound made by the computing device 100.

Thus, the computing device 100 may suffer from a variety of abnormal conditions that affect the sound generated by the computing device 100 (e.g., blocked air inlet or air outlet, loose fasteners, or mechanical components, etc.). These abnormal conditions are undesirable, as they may cause issues with the operation of the computing device 100 and prevent the computing device 100 from operating properly. However, because the computing device 100 is often remotely located or otherwise not accessed frequently, detection of these abnormal conditions may be difficult, as remote management of the computing device 100 (e.g., via the BMC 114) is often not able to detect such abnormal conditions.

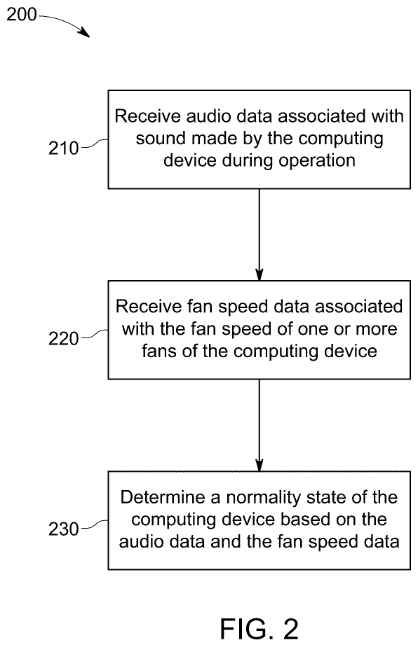

FIG. 2 is a flowchart of a method 200 for monitoring the computing device 100 using audio data generated by the microphone 118, and fan speed data generated by the fans 116A-116n and the PSU fan 124 (all shown in FIG. 1). In some cases, method 200 is implemented by the BMC 114 (FIG. 1).

Step 210 of method 200 includes receiving audio data associated with sound made by the computing device during operation. The audio data is generated by the microphone 118, and can be received at the BMC 114. In some implementations, the microphone 118 is disposed wholly within the housing 102 (FIG. 1) of the computing device 100. In other implementations, the microphone 118 is disposed partially within the housing 102 and partially outside of the housing. In further implementations, the microphone 118 is disposed wholly outside of the housing 102. In additional implementations, the audio data is generated by multiple microphones, such as one microphone disposed within the housing 102 and one microphone disposed outside of the housing 102.

The audio data may cover any suitable period of time, such as 1 second, 5 seconds, 10 seconds, 20 seconds, 30 seconds, 1 minute, 5 minutes, etc. The audio data may also be in any suitable format. For example, in some implementations, the audio data is pulse-code modulation (PCM) audio data, where the audio is sampled at a specific sampling rate, and wherein each sample has a specific bit depth (e.g., length). In some implementations, the audio data is PCM audio data with a sampling rate of 16 kilohertz and a bit depth of 16.

Step 220 of method 200 includes receiving fan speed data that is associated with the fan speed of any of the fans of the computing device 100, which in some cases includes the fans 116A-116n and the PSU fan 124. In some implementations, the fan speed data is indicative of the rate of rotation of each of the fans 116A-116n and the PSU fan 124. This rate of rotation could be measured on a per-second basis (e.g., a specific number of hertz), on a per-minute basis (e.g., a specific number of revolutions per minute, or RPM), or on any other suitable basis. In other implementations, the fan speed data is indicative of the value (or some other property) of a control signal sent to the fans 116A-116n and the PSU fan 124. For example, in some cases the BMC 114 controls the fans 116A-116n and the PSU fan 124 via pulse-width modulation. The BMC 114 sends controls signals to the fans 116A-116n and the PSU fan 124 that take the form of a rectangular wave with a specific duty cycle. By varying the duty cycle of these rectangular waves (e.g., by modulating the width of the pulses in the control signals), the BMC 114 can control the speed of the fan (e.g., the rate of rotation). The fan speed data can thus be indicative of, for example, the value of the duty cycle (e.g., 25%, 50%, etc.) over a period of time.

In some implementations, receiving the fan speed data at step 220 includes the BMC 114 actively receiving fan speed data from the fans 116A-116n and the PSU fan 124. In these implementations, the fan speed data may be generated by the fans themselves, and transmitted to the BMC 114. In other implementations, receiving the fan speed data at step 220 includes the BMC 114 specifically storing data that the BMC 114 has generated.

Step 230 of method 200 includes determining a normality state of the computing device 100 based at least in part on the audio data and the fan speed data. The normality state of the computing device 100 will generally indicate the presence or absence of a variety of different abnormal conditions that affect the sound made by the computing device 100 during operation, based on a comparison between the sound currently being made by the computing device with the specific fan speed data, and the sound that is expected to be made by the computing device with that same fan speed data.

The abnormal conditions may include any of those discussed herein, including a partial or full blockage of the air inlet of the housing 102; a partial or full blockage of the air outlet of the housing 102; a loosening of the coupling between a mechanical component (e.g., an expansion card) and another device (e.g., a motherboard) to which the mechanical component is coupled; a looseness of one or more fasteners of the computing device 100 (e.g., screws attaching the motherboard to the housing 102); other abnormal conditions that may affect the sound made by the computing device 100 during operation; or any combination thereof.

In some implementations, the normality state of the computing device 100 may be indicated by the value of a plurality of variables, where each variable is associated with a different abnormal condition. In some implementations the variables are binary with only two possible values, one of the values (e.g., 0) indicating that the corresponding abnormal condition is not present, and the other value (e.g., 1) indicating that the corresponding abnormal condition is present. Thus, a value of 0 (for example) for a variable associated with air inlet blockage indicates that the air inlet is not blocked, while a value of 1 (for example) for a variable associated with air outlet blockage indicates that the air outlet is blocked. In some of these implementations, the binary values could also be assigned to different degrees of the abnormal conditions. For example, the value associated with air inlet blockage could have a value of 0 if the amount of blockage is between 0% and 50%, and a value of 1 if the amount of blockage is between 50% and 100%.

In other implementations, the variables can have three or more different values so as to be able to indicate a degree of the abnormal condition. For example, the variable associated with air inlet blockage could have a value between 0 and 4. A value of 0 indicates no blockage, a value of 1 indicates 25% blockage, a value of 2 indicates 50% blockage, a value of 3 indicates 75% blockage, and a value of 4 indicates 100% blockage. Thus, the values of the variables can be used to indicate how blocked the air inlet and air outlet are, how loose various fasteners might be, how loose the connection of various mechanical components might be, etc. In generally, references herein to the degree of an abnormal condition include the absence of the abnormal condition (e.g., a degree of 0).

In some implementations, the determination of the normality state is done by a machine learning model. In these implementations, the determination of the normality state at step 230 will include inputting the audio data and the fan speed data into the machine learning model, and receiving from the machine learning model an indication of the normality state. The machine learning model could be implemented on the computing device 100 itself (for example by the BMC 114), or on an external computing device. If implemented internally, the audio data and the fan speed data can be stored and kept locally on the computing device 100 (such as in a dedicated memory device of the BMC 114). If implemented externally, the audio data and the fan speed data will be transmitted to the external computing device (for example via the connection to the external network 120).

Any suitable machine learning model can be used. In some implementations, the machine learning model is a neural network. In some of these implementations, the machine learning model is a recurrent neural network (RNN) with one or more long short-term memory (LSTM) units. The indication of the normality state that is received from the machine learning model could have any suitable format. In some implementations, the indication could be a number corresponding to a specific combination of abnormal conditions. For example, a 0 could indicate no abnormal conditions; a 1 could indicate that a first abnormal condition is present but the second, third, and fourth abnormal conditions are absent; a 2 could indicate that the second abnormal condition is present but the first, third, and fourth abnormal conditions are absent; a 5 could indicate that the first and second abnormal conditions are present but the third and fourth abnormal conditions are absent, etc.

In other implementations, the indication of the normality state that is output by the machine learning model is the value of each of the variables associated with the various different conditions. For example, variable A is associated with air inlet blockage, variable B is associated with air outlet blockage, variable C is associated with the looseness of the coupling of one or more mechanical components, and variable D is associated with the looseness of one or more fasteners, then the output of the machine learning model could be A=a, B=b, C=c, and D=d, where the lowercase letters are the specific values of the corresponding variable. The variables could have binary values indicating the presence or absence of the abnormal conditions, or the variables could have three or more possible values so as to indicate the degree of the abnormal conditions.

In general, each respective combination of the presence and absence of the abnormal conditions can be given a preassigned label, where the label uniquely identifies the respective combination. The label could be in alphanumeric format, or could be a specific X-digit number representing the values of each of the variables for X number of different abnormal conditions.

In some implementations, method 200 further includes generating a message that is indicative of the normality state of the computing device 100. This message could be automatically generated (e.g., by the BMC 114 or the CPU 104) and sent to a user or administrator of the computing device 100. The message may include generally any desired information about the normality state, such as indication that an abnormal condition is present, the value of each of the variables, etc. The indication that an abnormal condition is present may be solely a binary indication that either an abnormal condition is present or no abnormal conditions are present, but may also include specific information about an abnormal condition that is determined to be present. For example, the message can include information about a broad category to which the abnormal condition belongs, such as an “air flow” category or a “looseness” category. The message could additionally or alternatively include information about a more specific identity of the abnormal condition, such as whether the abnormal condition is associated with at least a partial blockage of the air inlet, at least a partial blockage of the air outlet, a loosening of the coupling of one or more fasteners, a loosening of the coupling of none or more mechanical components, or any combination thereof. The message could additionally or alternatively include information about the degree of any identified abnormal condition, such as an indication that the air inlet is 25% blocked, a fastener has become 50% unscrewed, etc.

In some implementations, the machine learning model is configured to generate the message. In other implementations, the BMC 114 receives the output of the machine learning model (e.g., the indication of the normality state) and uses that indication to generate the message.

In some implementations, the computing device 100 implements method 200. In these implementations, the computing device 100 will generally include at least the housing 102 (having an air inlet and an air outlet), one or more electronic components disposed at least partially within the housing 102 (e.g., the CPU 104, the PCH 108, the PSU 122, etc.), one or more fans configured to cause air to flow through the housing 102 and remove heat generated by the electronic components (e.g., the fans 116A-116n, the PSU fan 124, etc.), the microphone 118 disposed at least partially within the housing 102 and configured to generate the audio data associated with the operation of the computing device 100, and the BMC 114 disposed within the housing and communicatively coupled to the one or more fans and the microphone 118. The BMC 114 can receive the audio data from the microphone 118 and the fan speed data from the one or more fans, and can determine the normality state of the computing device 100 based on the audio data and the fan speed data.

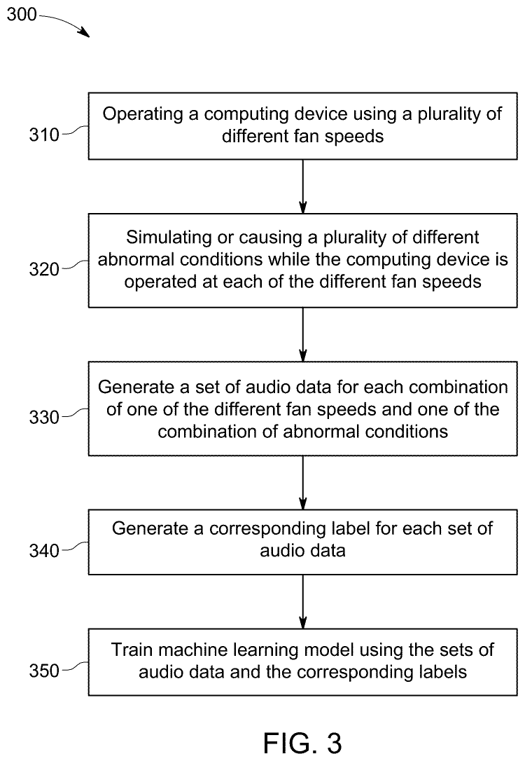

FIG. 3 illustrates a method of training a machine learning model to determine the normality state of the computing device 100 (FIG. 1) having the fans 116A-16n (FIG. 1) and/or the PSU fan 124 (FIG. 1), collectively referred to as the one or more fans.

Step 310 of method 300 includes operating the computing device 100 using a plurality of different fan speeds of the one or more fans. In some cases, all of the fans are set to operate at a given fan speed at the same time. For example, each fan is operated at fan speed level 1, then each fan is operated at fan speed level 2, then each fan is operated at fan speed level 3, etc. In other cases, operating the computing device 100 using the plurality of different fan speeds may include operating some of the fans at different fan speeds than other fans. For example, if the computing device includes the fans 116A-116n and the PSU fan 124, then the fans 116A-116n can be cycled through the different possible fan speed levels (generally with all of the fans 116A-116n at the same fan speed level) while the PSU fan 124 is at fan speed level 1, the fans 116A-116n can then be cycled through the different possible fan speed levels while the PSU fan 124 is at fan speed level, and so on. In various implementations, step 310 includes operating the computing device 100 at generally all of the possible fan speed levels for the one or more fans of the computing device 100. In practice, different fans in a computing device such as a server may adjust their speeds based on the readings from the temperature sensors of the components they are cooling. For example, since certain components such as CPUs, GPUs, and SSDs generate high levels of heat, the fans located near these components will run at higher speeds than other fans.

Step 320 includes simulating or causing a plurality of different abnormal conditions while the computing device 100 is operated at each of the different fan speeds. In general, step 320 will include causing or simulating every possible combination of abnormal conditions that the computing device 100 may be able to experience. For example, the computing device 100 may be operated at each of the different fan speeds while the air inlet is 25% blocked and all other conditions are normal, then the computing device 100 may be operated at each of the different fan speeds while both the air inlet and the air outlet are 25% blocked and all other conditions are normal, and so on. Thus, if there are X different possible abnormal conditions, and each abnormal condition is either present or absent (e.g., the variable for each abnormal condition can only have a binary value indicating presence or absence), then for each of the different fan speed levels that the computing device 100 is operated at, 2× different combinations of abnormal conditions will be caused or simulated, which includes a combination with no abnormal conditions present and a combination with all abnormal conditions present. If there are X different possible abnormal conditions and every condition could have Y different degrees (e.g., the variable for each abnormal condition can have Y different values to indicate the degree of the abnormal condition), then for each of the different fan speed levels that the computing device 100 is operated at, YX different combinations of abnormal conditions will be caused or simulated.

Step 330 of method 300 includes generating a plurality of sets of audio data while the computing device 100 is operated at the different fan speeds and the plurality of abnormal conditions are caused or simulated. Each set of audio data will be associated with sound made by the computing device 100 while it is operated with a distinct combination of (i) one of the plurality of different fan speeds and (ii) either none of the abnormal conditions present, or at least one of the abnormal conditions present.

In general, steps 310, 320, and 330 will be performed at the same time, so that audio data of all the different combinations of fan speeds and abnormal conditions can be generated. However, in some cases, certain portions of any of steps 310, 320, and 330 may be performed before or after others, so long as the sets of audio data are generated.

Step 340 includes generating a corresponding label for each respective set of audio data. The label indicates, for each respective set of audio data, whether the respective set of audio data corresponds to operation of the computing device 100 with no abnormal conditions present, or with an identified combination of one or more abnormal conditions present. In some implementations, the label may be the values of each of the variables that correspond to the combination of abnormal conditions. In other implementations, the label may be a unique identifier for each combination, such as a specific combination of numbers and/or letters.

Step 350 includes training the machine learning model using each of the plurality of sets of audio data and the corresponding label for each set. Any suitable type of training can be used, including supervised learning, unsupervised learning, etc. In some implementations, each set of audio data is input into the machine learning model, and the resulting output is compared to the label. Based on the difference between the output and the label, various parameters of the machine learning model can be updated, such as the various weights and biases of individual cells in a neural network. In some cases, the difference between the output and the label is measured by a loss function, and the parameters of the machine learning model are updated in an effort to minimize the loss function, for each set of audio data and its corresponding label.

Method 300 can be implemented wholly or partially on any suitable computing device, including computing device 100. For example, in some cases steps 310, 320, and 330 are performed using the computing device 100 to generate the sets of audio data. Step 340 (generating the labels for the sets of audio data) and step 350 (training the machine learning model) may be performed on the computing device 100, or on a separate computing device.

Although the disclosed embodiments have been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

While various embodiments of the present disclosure have been described above, it should be understood that they have been presented by way of example only, and not limitation. Numerous changes to the disclosed embodiments can be made in accordance with the disclosure herein, without departing from the spirit or scope of the disclosure. Thus, the breadth and scope of the present disclosure should not be limited by any of the above described embodiments. Rather, the scope of the disclosure should be defined in accordance with the following claims and their equivalents.

What is claimed is:

1. A method of monitoring a computing device, the method comprising:
receiving audio data associated with sound made by the computing device during operation, the computing device including one or more electronic component disposed at least partially within a housing;
causing air to flow through the housing, the air flowing from one or more fans of the computing device, the air removing heat generated by the one or more electronic components;
receiving fan speed data associated with a fan speed of each of the one or more fans; and
determining, based at least on the audio data and the fan speed data, a normality state of the computing device, the normality state being associated with a presence or absence of one or more abnormal conditions that affect the sound made by the computing device during operation.

2. The method of claim 1, wherein the normality state is associated with a plurality of variables, a value of each of the plurality of variables indicating whether a respective one of the one or more abnormal conditions is present.

3. The method of claim 2, wherein the plurality of variables includes at least one variable associated with an air inlet of the computing device, at least one variable associated with an air outlet of the computing device, at least one variable associated with one or more mechanical components coupled to the computing device, at least one variable associated with one or more fasteners coupled to or disposed within the housing of the computing device, or any combination thereof.

4. The method of claim 3, wherein the value of the at least one variable associated with the air inlet indicates a degree of blockage of the air inlet.

5. The method of claim 3, wherein the value of the at least one variable associated with the air outlet indicates a degree of blockage of the air outlet.

6. The method of claim 3, wherein the value of the at least one variable associated with the one or more mechanical components indicates a degree of looseness of the coupling between the one or more mechanical components and the computing device.

7. The method of claim 3, wherein the value of the at least one variable associated with the one or more fasteners indicates a degree of looseness of the one or more fasteners.

8. The method of claim 3, further comprising generating a message indicating the normality state of the computing device, the message including (i) the value of each of the plurality of variables, (ii) an indication of whether at least one of the one or more abnormal conditions is present, or (iii) both (i) and (ii).

9. The method of claim 8, wherein the indication of whether at least one of the one or more abnormal conditions is present includes (i) an indication that none of the one or more abnormal conditions is present or (ii) an indication that at least one of the one or more abnormal conditions is present.

10. The method of claim 8, wherein when at least one of the one or more abnormal conditions is present, the indication includes information associated with (i) an identification of the at least one of the one or more abnormal conditions, (ii) a category of the at least one of the one or more abnormal condition, (iii) a location of the at least one of the one or more abnormal condition, (iv) a degree of the at least one of the one or more abnormal condition, or (iv) any combination of (i)-(iv).

11. The method of claim 8, wherein the one or more abnormal conditions includes (i) at least a partial blockage of the air inlet, (ii) at least a partial blockage of the air outlet, (iii) a loosening of the coupling of at least one of the one or more mechanical components, (iv) a loosening of at least one of the one or more fasteners, or (v) any combination of (i)-(iv).

12. The method of claim 1, wherein determining the normality state of the computing device includes:
inputting the audio data and the fan speed data into a machine learning model; and
receiving from the machine learning model an indication of the normality state of the computing device.

13. The method of claim 12, wherein the machine learning model is a neural network.

14. The method of claim 13, wherein the machine learning model is a recurrent neural network (RNN) with at least one long short-term memory (LSTM) unit.

15. The method of claim 12, wherein the machine learning model is implemented by a baseboard management controller (BMC) of the computing device.

16. The method of claim 1, wherein the audio data includes pulse-code modulation (PCM) audio data with a sampling rate of 16 kilohertz and a bit depth of 16.

17. The method of claim 1, wherein the one or fans of the computing device include at least one fan configured to remove heat from a power supply unit (PSU) of the computing device, at least one fan configured to remove heat from a central processing unit (CPU) of the computing device, or both.

18. The method of claim 1, wherein the normality state of the computing device is indicative of a difference between (i) the sound made by the computing device during operation and (ii) sound made by the computing device during operation without any abnormal conditions, the difference being caused by the presence of at least one of the one or more abnormal conditions.

19. A computing device comprising:
a housing having an air inlet and an air outlet defined therein;
one or more electronic components disposed at least partially within the housing;
one or more fans configured to cause air to flow through the housing and remove heat generated by the one or more electronic components;
a microphone disposed at least partially within the housing and configured to generate audio data associated with sound made by the computing device during operation; and
a baseboard management controller (BMC) disposed within the housing and communicatively coupled to at least the one or more fans and the microphone, wherein the BMC is configured to:
receive, from the microphone, the generated audio data associated with the sound made by the computing device during operation;
receive, from the one or more fans, fan speed data associated with a fan speed of each of the one or more fans; and
determine, based at least on the audio data and the fan speed data, a normality state of the computing device, the normality state being associated with whether the computing device is operating under a presence of one or more abnormal conditions.

20. A method of training a machine learning model to determine a normality state of a computing device having one or more fans, the method comprising:
operating the computing device using a plurality of different fan speeds of the one or more fans;
for each of the plurality of different fan speeds, simulating or causing a plurality of abnormal conditions;
generating a plurality of sets of audio data, each respective set of audio data associated with sound made by the computing device during operation of the computing device with a combination of (i) one of the plurality of different fan speeds and (ii) either (a) none of the plurality of abnormal conditions or (b) one or more of the plurality of abnormal conditions;
generating a corresponding label for each respective one of the plurality of sets of audio data, the label indicating that the respective set of audio data corresponds to operation of the computing device (i) without any of the plurality of abnormal conditions present or (ii) with an identified one or more of the plurality of abnormal conditions; and
training the machine learning model using each of the plurality of sets of audio data and the corresponding label for each respective one of the plurality of sets of audio data.
